(19) United States
(12) Patent Application Publication
(10) Pub. No.: US 2008/0209516 A1
(43) Pub. Date: Aug. 28, 2008

(54) Signature and identity authentication and documentation using a third party witnessed authenticator via a video conference

(76) Inventor: Nick Nassiri, Los Angeles, CA (US)

Correspondence Address: NICK NASSIRI, 11222 LA CIENEGA BLVD. #150, INGLEWOOD, CA, 90304, US

(21) Appl. No.: 11/710,169

(22) Filed: Feb. 23, 2007

(51) Int. Cl. H04L 9/32

(52) U.S. Cl. 726/3

(57) ABSTRACT

The method of the present invention functions to perform signature and identity authentication using a third party witness whereby the parties are enjoined via a video conference and whereby an authorized identity document is created. The invention is suited to transactions that require a legally binding, traditional witnessed authentication. The method of the present invention creates legally binding documents that comprise biometric information, including at least one of the group of, a passport, a drivers license, government issued identity card, or an corporate identity document.

### CROSS REFERENCE TO RELATED APPLICATIONS

The present application is a continuation of U.S. Pat. No. 6,094,416 filed Mar. 27, 2001 and issued Jun. 7, 2005 to Nick Nassiri entitled “SIGNATURE VERIFICATION USING A THIRD PARTY AUTHENTICATOR VIA A PAPERLESS ELECTRONIC DOCUMENT PLATFORM” and incorporated herein by reference.

### COPYRIGHT NOTICE

A portion of this disclosure of this patent document contains material that I subject to copyright protection. The copyright owner has no objection to the reproduction by anyone on the patent office pertaining to the patent reproduction or disclosure as it appears in the US Patent and Trademark Office, patent file, or records, but otherwise retains all copyright rights whatsoever,

### DESCRIPTION

Parties authorized to the transaction initiate a video conference involving at least one of: a witnessed authenticator, typically a notary public, an authorized party, and a signatory for the purpose of creating a legally binding identity document. Said video conference comprises at least a network architecture for a video communications system, comprising at least: a server for receiving login data for a video conference from the plurality of authorized participants, each participant being associated with a video conference machine; an authorized party to control the login data; an audio or visual viewer comprising at least: a network interface configured to receive audio or visual signals from the plurality of participants; a system for compressing and decompressing audio or visual signals; and a video display for displaying the video signals transmitted from the plurality of participants such that the video display simultaneously displays each visual signal from each participant of the plurality of participants.

Upon an authorized party initiating the video conference, an authorized party downloads an appropriate electronic document from an electronic document repository and inputs the required information into the electronic document, for the purpose of creating an authorized identity document. After inputting each of the required information, the authorized party uploads the electronic document to an electronic document repository. An electronic transaction manager determines when all of the required information from each of the parties is present and amalgamates all of the information into a single final electronic identity document. The parties required to execute the electronic document are notified that the electronic document is ready to be electronically signed and electronically notarized or witnessed. The signatory inputs a manual, hand-written signature to the electronic document, using a electronic signature capture input device. The witnessed authenticator, typically a notary public inputs a manual, hand-written signature to the electronic document, using the electronic signature capture input device. The witnessed authenticator, typically a notary public, next affixes an electronic notary seal by way of the electronic notary seal input device. After affixing the notary public's signature and seal, a desktop manager automatically executes an electronic notary journal. The electronic notary journal consists of all of the information required by law to legally enforce the notarization of the electronic commerce transaction.

### BACKGROUND OF THE INVENTION

1. Field of the Invention

The present invention generally relates to the field of signature or identity verification with the purpose of creating authenticated identity documents via a video conference.

2. Description of the Prior Art

Used effectively, video conferencing has a dramatic effect on the way people do business and the productivity gains they can derive. Today, video conferencing systems transcend the traditional exchange of conversation between parties on a screen. The ability to collaborate and share information has added another dynamic to video communications, often previously not even possible in a local meeting. For example, it is now possible to enjoin geographically remote parties real time to share and input information into a single document via a video conference. Nonetheless, there currently exist no methods or processes whereby an individual's signature or identity can be authenticated real-time between geographically remote parties enjoined by video conference processes and methods. One still needs to physically travel to the DMV, a court house, or relevant state agencies to have their identity verified and have an authenticated identity document created.

Identity paper based transactions such as a passport or a license are traditional but cumbersome processes that involves many separate entities, diverse parties and involves multiple documents to consummate the transaction. Likewise, preparing, transferring and delivering the paper documents for signature on such document-laden transactions remains an expensive, slow, paper-based, offline process. The problems of excess documents and lapses in time are compounded by the fact that the parties to such type transactions are typically numerous and geographically dispersed. Therefore, such type transactions incur considerable amounts of time and money to transport the necessary documents between the geographically dispersed parties.

Video conferencing can be used to achieve significant benefits beyond increased productivity and reduced costs. Authoritative identity documents require vast amounts of time and money to process. By way of example, standing in line for hours to renew a drivers license or obtain a passport is hardly productive or cost friendly for either party. Time and money are lost while the documents must be presented physically, in-person for review by the authorized witnessed signatory. Additionally, such type transactions have been largely unable to take advantage of on-line transactions because of the preemptive legal/business practice requirement that a notary public or authorized party authenticate the signature or the identity of an individual to bind the transaction. To date, there exists no integrated solution whereby these types of transactions can be conducted on-line via a video conference using a paperless document platform that encompasses the necessary component of signature verification or identity verification to conclude the transaction.

Although an increasing number of such type transactions may be initiated online, they are invariably consummated off-line due to the inability to integrate the parties via a video conference. Further, there exists no method of on-line notarization or witnessed authentication that meets the expectations or standards of a duly notarized signature done by a licensed notary public. Moreover, there exists no integrated process or method that integrates the parties and entities to such transactions on-line using a video conference system that is accessible by all of the parties to the transaction.

Nonetheless, there exists a real need to redress the problems addressing such type transactions to create authenticated identity documents real-time via a video conference that comply with the standards and processes of a duly notarized signature or witnessed authentication. Notarization, legally and traditionally, requires an independent, in-person verification of the identity and signature using a live commissioned notary public who affixes a notary seal and jurat as a means of authentication. Existing products and solutions typically use code-based digital certificates issued by a licensed certification authority as a means to verify a signature. Digital certificates are a function public key cryptography whereby a person's signature is converted to a digital code. Such processes operate so that a person's identity is verified a single time when the digital certificate is issued by the issuing authority. The applicant subsequently uses the code associated with the digital certificate each time his or her signature is required. The end result being that a signatory may use the digital certificate to unilaterally affix a “notarized” signature to an electronic document, when in fact no has witnessed or authenticated the identity of the signatory.

The problem associated with public key cryptography methods is that while the certification authority is capable of issuing a certificate that correspond to an applicant, it is unable to verify the identity of the person who is signing the electronic document at the time the digital certificate is used. The inability of public key cryptography to guarantee a person's identity has precluded such type transactions from effectively electronic based commerce to conclude such transactions.

The prior art reveals the following prior art patents are found to be related to the field of signature verification although none of them provide an integrated approach to signature verification using a paperless electronic document platform.

United States Patent Application No. 200120009412078 filed by Pasha Athar et al for “Method and apparatus for conducting a video conference”. The Arthur patent application discloses a method whereby a video conferencing terminal includes an encoder that receives a baseband audio signal and a baseband video signal and creates compressed audio packets and compressed audio-video packets. A network interface driver receives the compressed audio packets and the compressed audio-video packets, IP encapsulates the compressed audio packets and the compressed audio-video packets, transmits the IP packets onto an IGMP network. The network interface driver also requests audio packets and audio-video packets from the network and recovers compressed audio packets and compressed audio-video packets from the IP packets received from the network. A decoder receives compressed audio packets and compressed audio-video packets from the network interface driver and generates a baseband video signal and multiple baseband audio signals.

United States Patent Application No. 20060244812 filed by Jeong; Hyeonkuk et al. The Jeong patent application discloses a method whereby an architecture for establishing multi-participant video conferences. This architecture has a central distributor that receives video images from two or more participants. From the received images, the central distributor generates composite images that the central distributor transmits back to the participants. Each composite image includes a set of sub images, where each sub image belongs to one participant. In some embodiments, the central distributor saves network bandwidth by removing each particular participant's image from the composite image that the central distributor sends to the particular participant. In some embodiments, images received from each participant are arranged in the composite in a non-interleaved manner. For instance, in some embodiments, the composite image includes at most one sub-image for each participant, and no two sub-images are interleaved.

U.S. Pat. No. 4,821,118 issued to Lafreniere for “Video image system for personal identification”. The Lafreniere patent discloses a video image system for rapidly (in a few seconds) recording a person and his identification (ID) card makes video images of the person's hand palm and face along with the ID card presented by the person that may be a badge, card, drivers license, passport, or other item issued by some authority, and combines those images and presents the combined image on a video monitor for immediate inspection by a guard, store clerk or attendant, and, in addition, stores the combined image along with time and date superimposed thereon so that it can be reviewed later. The system includes at a designated place entered by the person to be recorded, a viewing table in easy reach of the person on which there are viewing areas for the person's palm and the ID card that he presents and video cameras arranged for scanning his palm, ID card and his face producing video images that are combined electronically producing a combined video image of the palm. ID card and face that is viewed on a video monitor and recorded on a video cassette recorder (VCR) along with the time and date. The combined image that is recorded can be reviewed later as a review of the identification event.

U.S. Pat. No. 7,092,011 issued to Schulz for “Video conferencing system with physical cues”. The Schulz patent discloses video-conferencing system that provides physical cues regarding remote participants. Each remote participant is physically represented at a video conference by a robotic unit that includes a monitor, camera, microphone and speaker. In this way, a physical presence of the remote participant is conveyed at the conference, so that other participants are more likely to involve the remote participant. Moreover, the remote participant has access to a gesture determination system, which inputs gesture information about the remote participant that expresses a state of mind of the participant. Such gesture information may include leaning forward to show interest, or leaning back to show disinterest. The gesture information is transmitted to the robotic unit, which is actuated so as to reflect the gesture information, and thereby express the state of mind of the remote participant in a physical, intuitive way.

U.S. Pat. No. 6,989,81206 issued to Firestone et al for “System and method for providing video conferencing synchronization”. The Firestone patent discloses a method for executing a video conference is provided that includes receiving one or more audio streams associated with a video conference from one or more end points and determining an active speaker associated with one of the end points. Audio information associated with the active speaker may be received at one or more media switches. One or more video streams may be suppressed except for a selected video stream associated with the active speaker, the selected video stream propagating to one or more of the media switches during the video conference. The selected video stream may be replicated such that it may be communicated to one or more of the end points associated with a selected one of the media switches.

U.S. Pat. No. 6,792,143 issued to Harmovaara for “Recognition of handwriting in mobile station”. The Harmovaara patent discloses a method in which graphic information may be input to a terminal equipment via a touch-sensitive writing pad and at the same time presented on a display in parallel with the independent execution of other functions, and a portable terminal equipment according to the method, which comprises a voice communicator (for text and file storage and transmission functions) and a display for presenting visual information as well as a graphic writing pad for entering input data in graphic format to the terminal equipment. In a communicator according to an embodiment of the invention a video terminal may be used in the information input simultaneously as a graphic writing pad and a display of the video terminal. The invention enables deaf and dumb people to communicate and take part in a video conference.

U.S. Pat. No. 6,317,777 issued to Skarbo et al for “Method for web based storage and retrieval of documents”. The Skarbo patent discloses a document-collaboration videoconferencing system between a first and a second conference attendee. In one embodiment, the system comprises a document server, a local presenter computing system, and a conferencing computing system. In this embodiment, the local presenter computing system transfers a document to the document server over a network, and the first conferencing system copies such document over the network from the document server.

U.S. Pat. No. 120,742,68120 issued to Berson et al. for “Method For Verifying An Identification Card And Recording Verification Of Same” (hereafter the “Berson patent”). The Berson patent discloses a method for verifying an identification card and recording verification of the same. The identification card includes information on a first portion of the card, the information including personal information relating to the person to be identified, and an encrypted representation of at least part of the information on a second portion of the card, the part including the personal information. The encrypted information can be read from the card and then decrypted to obtain a decrypted representation. The card is then verified by comparing the decrypted representation of the information with the information on the first portion of the card and the personal information is stored as at least part of a record of the verification transaction. The Berson patent further discloses a record system which includes a source identification such as a machine number and a secure tamper proof clock.

U.S. Pat. No. 120,912,974 issued to Holloway et al. on Jun. 1120, 1999 for “Apparatus And Method For Authentication Of Printed Documents” (hereafter the “Holloway patent”). The Holloway patent discloses an apparatus and method for authentication of printed documents. The printed documents are scanned and digitized using a conventional scanner. The scanned and digitized document contents are edited before being used to generate a digital signature. This allows reading errors which could invalidate a subsequent verification process to be corrected. Using the editor and an input device, the signing authority identifies on the screen different segments of the document. Each segment contains data of a single type and selects a set of rules, among a group proposed by the system, for authenticating the document. Then, for each segment, an edited digital form of the data contents is derived using the method defined in the rules. A hash value of the rules used and the edited digital form of the segment contents is calculated using a public hashing algorithm. Then the apparatus generates a digital signature of the edited digitized segment contents using the secret key of the authenticator. Finally, an authentication code comprising the edited digital form of each segment and the digital signature is printed on the document. To verify the authenticity, the printed document is scanned and digitized again and the digital signature is checked by using the associated public key. If the check fails, the verifier identifies which segment has been scanned differently, comparing it with the related edited digital form in the authentication code printed on the document to evaluate its validity.

U.S. Pat. No. 120,872,848 issued to Romney, et al. on Feb. 16, 1999 entitled, “Method and apparatus for witnessed authentication of electronic documents.” The Romney patent consists of a method and apparatus for authenticating an electronic document using an electronic document authenticator. An electronic document authenticator is an individual or enterprise that has been authorized by the inventor witness a digital signature. The Romney patent does not use a licensed notary public nor does the Romney patent perform a method of notarization. Rather, the Romney patent is a form of public key encryption verification whereby the authorized party enters a digital code, presumed to be the equivalent of his or her written signature, in the presence of the authenticator. The authenticator verifies the digital certificate belongs to the authorized party that used it by using a corresponding public key provided by the same authorized party. The Romney patent essentially ascertains that the public key supplied to the authenticator by the authorized party matches the private key used by the authorized party to produce the digital signature. The Romney patent fundamentally is a solution to deal with one of the most common problems associated with public key cryptography: identity theft. It is not a form of a method of traditional notarization. The Romney patent is premised on the issuance of digital certificates to be used by all parties, including the authenticator, to attest to the veracity of a document, as opposed to the authenticity of an identity and corresponding signature, per the method of a traditional notarization performed by a licensed notary public.

U.S. Pat. No. 120,926,1201201 issued to Dwork et al. on Jul. 20, 1999 for “System And Method For Certifying Content Of Hard-Copy Documents” (hereafter the “Dwork patent”). The Dwork patent discloses a system and method for certifying content of hard-copy documents. A digital representation of the data object is produced, typically, for hard-copy documents to produce a two dimensional bit map. Then, a signature for the digital representation is obtained from a certifying agent. The signature is produced as a function of the digital representation of the data object, so as to reflect the content of the data object. This will commonly be performed by a certifying agent, such as a post office clerk or a notary public. As a result, a representation of the signature, along with the data object is provided. Accordingly, it is established that the signature authenticates the content of the data object.

U.S. Pat. No. 120,940,187 issued to Berke on Aug. 17, 1999 for “Method For Certifying Facsimile Communication Over A Telephone Network” (hereafter the “Berke patent”). The Berke patent discloses a method for certifying facsimile communications over a telephone network. The method includes a registration sequence during which an originator of facsimile messages establishes an account with the certifying system by providing a handwritten signature and identifying data. The handwritten signature is linked to the identifying data, and the identifying data is utilized through the method in an effort to insure the authenticity of facsimile messages certified by the certifying system.

U.S. Pat. No. 120,973,731 issued to Schwab on Oct. 26, 1999 for “Secure Identification System” (hereafter the “Schwab patent”). The Schwab patent discloses a secure identification system for providing a secure interactive communication of text and image information between a central server computer and one or more client computers, located at remote sites for the purpose of storing and retrieving files describing and identifying unique products, services or individuals.

A major problem to conducting electronic transactions that requires signature or identity verification, is that to date there exists no method whereby electronic identity documents can be electronically notarized using the traditional and legally binding method by a live, licensed notary public via a video conference.

It is desirable to provide a new method and system for providing signature or identity verification with the capability of signing and notarizing electronic documents at remote locations without the need to physically transport the hard copies of such documents to the remote locations to be signed by the signatories and notarized by a notary public.

While the devices created by the prior art may be suitable for the particular purpose to which they address, they are not as suitable for signature verification for electronic commerce transactions that typically require the traditional form and security of an in-person notarization.

In view of the foregoing disadvantages inherent in the known prior art, the present invention provides a new method for providing and performing identity and signature verification via a video conference on-line with the capability of electronically transporting, signing and notarizing the electronic documents. In this respect, the method of signature and identity verification with the capability of electronically transporting, signing and notarizing the electronic document according to the present invention, substantially departs from the conventional concepts and designs of the prior art. Further novel features and other objects of the present invention will become apparent from the following detailed description, discussion and the appended claims, taken in conjunction with the drawings.

### SUMMARY OF THE INVENTION

The general purpose of the present invention, which will be described subsequently in greater detail, is to provide a new method of identity and signature authentication by a an authorized third party, typically a notary public, using a paperless document platform via a video conference that is not anticipated, rendered obvious, suggested, or even implied by any of the prior art, either alone or in any combination thereof.

Described briefly, the method of the present invention function to provide and perform signature verification identity and signature authentication by a an authorized third party, typically a notary public, using a paperless document platform via a video conference. The invention is particularly suited to electronic transactions that require a traditional witnessed authentication or notarization by a live notary public, albeit in a format that is compatible to electronic documents, using a video conference. An authorized party wishing signature or identity verification for an electronic document runs a desktop manager on the browser of a local computer system to interface with the functions and features of the present invention. To initiate a transaction, the authorized party first must register with an electronic transaction manager which structures the transaction request and manages the transaction cycle, including initiation of the video conference. Upon registering with the electronic transaction manager, a authorized party may download an appropriate electronic document or set of electronic documents (referred to as the “electronic document”) from an electronic document repository. After downloading an electronic document, the electronic transaction manager assigns a password and a name to the electronic document. The authorized party inputs the required information into the electronic document using a local computer system. After inputting all of the required information, the authorized party uploads the electronic document to the electronic document repository. The electronic transaction manager records the transaction in the electronic transaction manager database, and posts the electronic document for retrieval by a subsequent authorized party. A subsequent authorized party downloads the electronic document using an access password and the document name.

The parties to the transaction communicate with one another via the electronic transaction status board. The electronic transaction status board allows the parties to have constant and instant information and communication that is readily accessible. The electronic transaction status board functions as a virtual message center where the parties may inform one another of the respective status of the electronic documents. Likewise, the electronic transaction status board functions to post information from the electronic transaction manger regarding the status of the electronic document and to post other information regarding the transaction cycle.

The electronic transaction manager determines when all of the required information from each of the parties is present and amalgamates all of the information into a single final electronic document. The electronic document is encrypted and assigned a corresponding temporary signing password. The temporary signing password is distinct from the initial password and the access password assigned to the electronic document. Upon assigning a temporary signing password, no information may be added, deleted or modified to the electronic document prior to signature. The parties required to execute the electronic document are notified that the electronic document is ready to be electronically signed and electronically notarized. Each signatory is given the electronic document's name and the corresponding temporary signing password. The desktop manager highlights or otherwise indicates each and every place where a signature or the initials of the signatory are required in the electronic document. The signatory inputs a manual, hand-written signature to the electronic document, using a electronic signature capture input device. The notary public inputs a manual, hand-written signature to the electronic document, using the electronic signature capture input device. The notary public next affixes an electronic notary seal to the electronic document where indicated by the desktop manager. The notary public affixes the notary seal by way of the electronic notary seal input device.

After affixing the notary public's signature and seal, the desktop manager automatically executes the electronic notary journal. The electronic notary journal creates an independent electronic record of the notarization that remains in the sole possession of the notary public. The electronic notary journal consists of all of the information required by law to legally enforce the notarization of the transaction. After recording the transaction in the notary journal, the signed, notarized electronic document is encrypted and a time/date stamp is applied. Any changes made to the electronic document after this point in time invalidate the electronic document. Upon finalization of the electronic document, the video conference is terminated by the transaction manager.

It has been discovered, according to the present invention, that if transactions requiring an electronic identity card can be electronically notarized using an in-person method of notarization and a paperless transaction platform, such type of transactions can be conducted on-line via a video conference thereby saving substantial amounts of time and money.

It has been discovered, according to the present invention, that if transactions requiring an identity authentication can be electronically notarized using an in-person method of notarization and a paperless transaction platform, such type of transactions can be conducted on-line via a video conference thereby saving substantial amounts of time and money.

It has been discovered, according to the present invention, that if transactions requiring signature authentication can be electronically notarized using an in-person method of notarization and a paperless transaction platform, such type of transactions can be conducted on-line via a video conference thereby saving substantial amounts of time and money.

It has been discovered, according to the present invention, that if transactions requiring traditional notarization can be electronically notarized using an in-person method of notarization and a paperless transaction platform, such type of transactions can be conducted on-line via a video conference thereby saving substantial amounts of time and money.

It has been discovered, according to the present invention, that if the access and transport of electronic documents and notary public services can be accomplished online via a video conference, that the executed electronic documents can be rapidly verified and validated without waiting for paper documents to be physically shipped to a remote location or without having the parties travel to a remote location, thereby saving substantial amounts of time and money.

It has been discovered, according to the present invention, that if identity or signature verification services using a paperless transaction platform can be accomplished online via a video conference, then sensitive agreements, or high-value transactions and the like, which traditionally and legally require a notary seal, do not sit on hold and can be executed more rapidly and efficiently.

It has additionally been discovered, according to the present invention, that if notary services paperless transaction platform can be accomplished online via a video conference, it reduces courier costs and possible delay by the couriers who transport the documents to remote locations to be signed.

It is therefore an object of the present invention to provide a method for performing identity and signature verification using a notary public and a paperless transaction platform via a video conference, with the capability of rapidly signing and notarizing electronic documents at remote locations without physically transporting the documents to the remote location to be signed by signatories and notarized by a participating notary public at the remote location.

It is a further object of the present invention to provide a method and system for providing and performing electronic notary services using a paperless document platform via a video conference, where notarizations can take place at the notary's place of business having internet access or wherever there is internet access.

It is a further object of the present invention to utilize the most trusted and secure form of identity and signature verification, a licensed notary public, via a video conference, to execute binding legal electronic documents.

It is a further object of the present invention to enable high value or sensitive electronic document transactions requiring an in-person notarization to be conducted on-line via a video conference using a paperless electronic document platform.

It is a further object of the present invention to integrate all of the parties to high value or sensitive transactions on-line via a video conference by providing a standardized set of electronic documents that are accessible on-line and interchangeable among the parties on-line, including the notary public.

It is still a further object of the present invention to provide a method and system for verifying and identifying an electronic signature of a signatory via a video conference by providing a key, code or pin number to the signatory so that the signatory can use the pin number at a later time to verify and identify his or her digital signature to a requesting party, vendor etc.

There has thus been outlined, rather broadly, the more important features of the invention in order that the detailed description thereof may be better understood, and in order that the present contribution to the art may be better appreciated. There are additional features of the invention that will be described hereinafter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Referring particularly to the drawings for the purpose of illustration only and not limitation, there is illustrated:

FIG. 1 is a flow chart diagram that illustrates the exemplary embodiment of the present invention;

FIG. 2 A-2B is a flow chart diagram that illustrates the preferred embodiment of the method of the present invention;

FIGS. 3-4D are a series flow chart diagrams that illustrate the exemplary method for using the electronic transaction manager to manage the paperless document transaction according to the method of the present invention.

FIG. 3 depicts the electronic transaction manager assigning an internal reference number/code that is distinct from the electronic document name and password code,

FIG. 4A depicts the electronic transaction manager assigning the electronic document a name and password code,

FIG. 4B depicts the authorized party assigning the electronic document a name and password code,

FIG. 4C depicts the electronic transaction manager using the foregoing internal reference number/code, and the electronic document a name, and the password code assigned to the electronic document to manage the transaction cycle;

FIG. 4D depicts the electronic transaction manager storing the electronic document data in the electronic management database;

FIGS. 120A-120C are flow chart diagrams that illustrate the authorized party and other authorized parties accessing the electronic document according to the method of the present invention;

FIGS. 120A-120C are flow chart diagrams that illustrate changes made to previously entered information and the processing of such changes according to the method of the present invention;

FIGS. 6A-6B are flow chart diagrams that illustrate the process of accessing and displaying an electronic document for signature verification according to the method of the present invention;

FIGS. 7A-7B are flow chart diagrams that illustrate the authorized party and notary public electronically signing the electronic document according to the method of the present invention;

FIGS. 8A-B is a flow chart diagram that illustrates the notary public notarizing the electronic document according to the method of the present invention;

FIG. 9 is a flow chart diagram that illustrates verifying the notary public according to the method of the present invention; and

FIG. 10 is a flow chart diagram that illustrates the execution of the notary public journal according to the present invention.

FIG. 11 is a flow chart diagram that illustrates the archival of the notary public journal according to the present invention.

### DETAILED DESCRIPTION OF THE PREFERRED EMBODIMENT

### I. Description of Present Invention

Although specific embodiments of the present invention will now be described in detail and with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

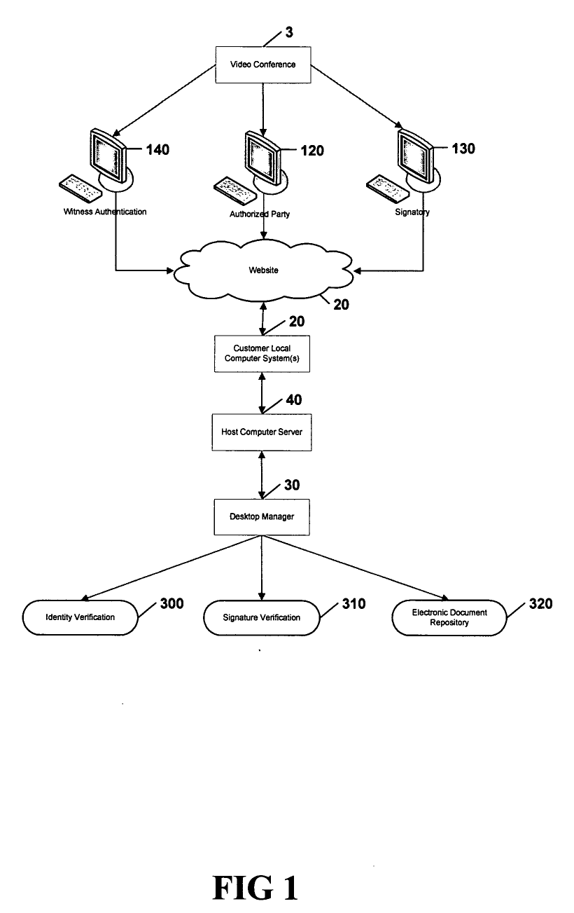

With reference to FIG. 1, the method of the present invention comprises a video conference 3, a witnessed authentication 140, a signatory 130, the internet or other TCP/IP based networks 20, a authorized party local computer system 20, a desktop manager 30, a host computer server 40, an electronic transaction manager 1200, an electronic transaction management database 60, electronic document repository 70, an electronic document 80, an electronic transaction 90, a rules-based integrity check 100, an electronic transaction status board 110, other authorized parties 120, a signatory 130, an electronic signature input device 13120, a notary public 140, notarization processes and methods 11200, an electronic notary seal input device 160, and an electronic notary journal device 170.

Any party to an electronic transaction that requires signature verification, the “authorized party” 120, may initiate a notarization request to electronic transaction manager 1200 using a authorized party local computer system 20. The authorized party 120 may be, but need not be, the signatory 130, whose signature is to be notarized by a notary public 140. For example, a loan officer, an escrow officer, or a regulatory agency may be the authorized party 120 that inputs information 190 into an electronic document 80 that eventually will be signed by a different signatory 130, for example, a loan applicant. The authorized party 120 accesses the present invention using a local computer system 20 from a remote location (i.e. the home, office, or a laptop) that establishes internet or TCP/IP connectivity 10 with the host computer server 40 using the desktop manager 30. The desktop manager 30 runs on the browser 21 of the local computer system 20 and provides the interface that allows the authorized party 120 to operate the present invention by the processes and methods described herein.

Likewise, the desktop manager 30 runs on the browser 21 of the authorized party local computer system 20 of the notary public 140 and provides the interface that allows the notary public 140 to operate the present invention by the processes and methods described herein. With respect to the authorized party 120, the desktop manager 30 is the interface that allows the authorized party 120 to access the present invention, establish a registration account 120120 with the electronic transaction manager 1200, navigate the electronic document repository 70, to download and upload 180 an electronic document 80 from the electronic document repository 70, to access the electronic transaction status board 110, and to input an electronic signature 24120 onto the electronic document 80 using the electronic signature input device 13120.

With respect to the notary public 140, the desktop manager 30, is the interface that allows the notary public 140 to establish a registration account 120120 with the electronic transaction manager 1200, to download and upload 180 an electronic document 80 from the electronic document repository 70, to access the electronic transaction status board 110, to input an electronic signature 24120 onto the electronic document 80 using the electronic signature input device 13120, to input an electronic seal 164 using the electronic notary seal input device 160, to execute notarization processes and methods 11200, to execute the electronic notary journal 170 and to authenticate the notary public 140 as being authentic 144.

The electronic transaction manager 1200 is an application that manages the paperless document transaction from the point of initiation by the authorized party 120 to the end point of notarization 11200 by a notary public 140. Initially, the authorized party 120 registers with the electronic transaction manager 1200 which in turn establishes a authorized party registration account 120120 in the electronic transaction manager database 60. The authorized party registration account 120120 is the basic upon which the electronic transaction manager 1200 correlates electronic documents 80 and keeps a record of the parties to a transaction. The electronic transaction manager 1200 is a function of the host computer server 40. The electronic transaction manager 1200 tracks and manages each electronic document 80 registered within the electronic transaction management database 60 using the registration information described fully below as a tracking mechanism and associating the information of the electronic transaction 90 with a particular authorized party registration account 120120. The electronic transaction manager 1200 also serves to authorize access by the other authorized parties 120 and the notary public 140 to a single electronic document 80, even though the other authorized parties 120 may be geographically remote, whether it be another city, another state, or another country.

The electronic document repository 70 consists of various electronic documents 80 that are specific to certain transactions and certain sectors or industries. For example, the electronic document repository 70 may consist of electronic documents 80 for the financial and banking sector, the real estate sector, or government/regulatory agencies and the like. The electronic documents 80 may be listed by type; i.e. deeds of trust, or by category; i.e. banking documents. A authorized party 120 may opt to post a “restricted access group” within the electronic document repository 70. A restricted access group consists of confidential electronic documents 80 that are proprietary to a specific authorized party 120 and may only be accessed or utilized by the registered authorized party 120. The restricted access group is password protected. In any category, the electronic document 80 may be represented singularly, or as a grouped set of electronic documents 80 (collectively referred to as the “electronic document”). The electronic document repository 70 may be used in conjunction with a request for signature verification or independently. In either scenario, the transaction must be initiated via the desktop manager 30 and managed by the electronic transaction manager 1200 as described herein.

The electronic transaction manager 1200 further consists of an electronic transaction status board 110. The electronic transaction status board 110 functions as an on-line virtual message communication center. The electronic transaction status board 110 automatically receives electronic transaction information 90 from the electronic transaction manager 1200. That is, upon a successful upload of the electronic document 80 to the electronic document repository 70, the electronic transaction manager 1200 automatically posts the time, date, and the party that posted the electronic document 80 to the electronic transaction status board 110. Likewise, the electronic transaction manager 1200 posts when a transaction cycle is complete, including the time and date of notarization on the electronic transaction status board 110. The electronic transaction status board 110 further functions as a virtual message center where the various parties to the transaction may inform one another of the respective status of the electronic document 80, i.e. a lender may be waiting on an appraisal, or the signatory 130 may be ill and unable to conclude the transaction at this point in time. Likewise, the parties may post questions or requests for other parties on the electronic transaction status board 110.

The electronic signature input device 13120 is a device that is remote 12120 to the authorized party local computer system 20 or is a function embedded within the authorized party local computer system 20. The electronic signature input device 13120 captures the manual, hand-written signatures of the signatory 130 and the notary public 140. The desktop manager 30 indicates on the browser 21 of the authorized party local computer system 20 where the electronic signature 24120 of the signatory 130 and the notary public 140 are to be input into the electronic document 80. The desktop manager 30 affixes the captured electronic signature 24120 of the signatory 130 and the notary public 140 to the electronic document 80. The electronic notary seal input device 160 is a device that is remote to the authorized party local computer system 20 that operates in conjunction with a function embedded within the desktop manager 30. Alternatively, electronic notary seal input device 160 is a device that is embedded in the authorized party local computer system 20 that operates in conjunction with a function embedded within the desktop manager 30. The electronic notary seal input device 160 executes an electronic notary seal 244 or an electronic notary jurat (collectively referred to as the “notary seal”) of the notary public 140 to the electronic document 80. The desktop manager 30 indicates on the browser 21 of the authorized party local computer system 20 where the electronic notary seal 164 is to be input into the electronic document 80, and the desktop manager 30 affixes the captured electronic notary seal 164 to the electronic document 80. The electronic notary journal 170 is a function of the desktop manager 30.

The electronic notary journal 170 executes upon a notary signature 24120 and seal 164 being affixed to the electronic document 80. The electronic notary journal 170 contains all of the verification information of the transaction required by law. Upon completion of the electronic document the video conference is terminated.

### II. Operation of the Present Invention

The method and system of the present invention function to provide and perform identity and signature verification services by a live notary public 140 via the internet or other TCP/IP based network 10 using a paperless document platform which consists of a video conference 3, a witnessed authentication 140, a signatory 130, an authorized party local computer system 20, a desktop manager 30, a host computer server 40, an electronic transaction manager 1200, an electronic transaction management database 60, electronic document repository 70, an electronic document 80, an electronic transaction 90, a rules-based integrity check 100, an electronic transaction status board 110, other authorized parties 120, a signatory 130, an electronic signature input device 13120, a notary public 140, notarization processes and methods 11200, an electronic notary seal input device 160, and an electronic notary journal device 170.

With reference to FIG. 1, a authorized party 120 with internet or TCP/IP connectivity 10 may either a website, a local access network (LAN) or a wide access network (WAN) using a client-server infrastructure, to provide the point of access to the present invention. In the preferred embodiment of the present invention, the request for signature verification using a paperless document platform is initiated by the authorized party 120 accessing a website on the world-wide-web using the authorized party local computer system 20. The website provides the authorized party 120 with information about the services available and information in the form of a tutorial on how to register with, and use the present invention. Alternatively, the invention may be configured for use an a restricted LAN or a restricted WAN.

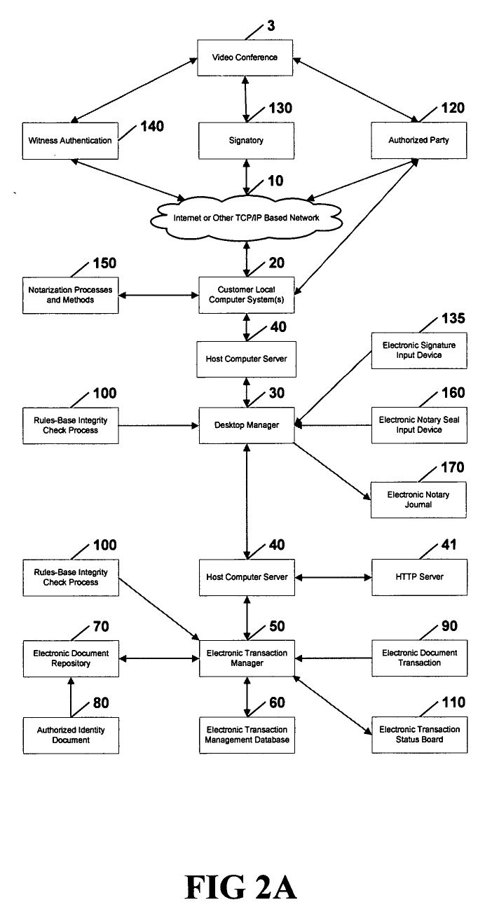

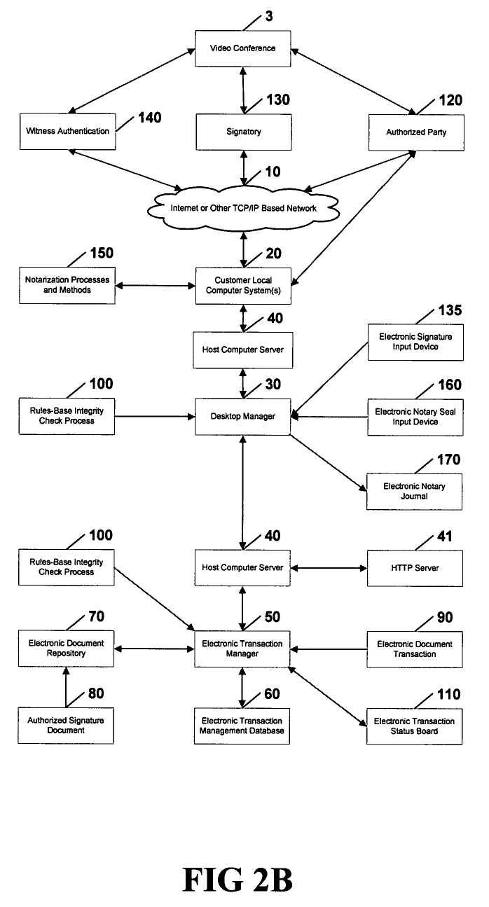

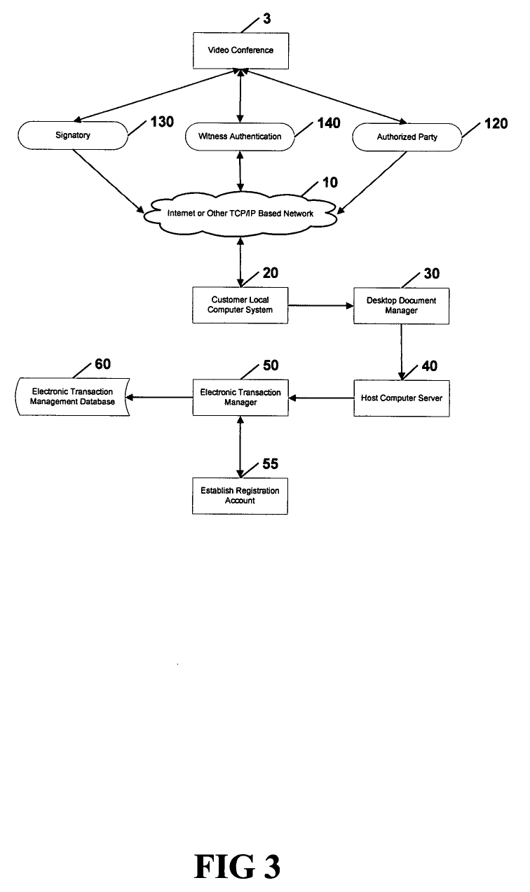

With reference to FIG. 2A, registration with the electronic transaction manager 1200 is a prerequisite to using the present invention by the authorized party 120, a video conference 3, a witnessed authentication 140, a signatory 130 and the notary public 140. The authorized party 120 and the notary public 140 establish a registration account 120120 in the same manner but for different reasons. The authorized party 120 and the notary public 140 establish a registration account 120120 with the electronic transaction manager database 60 by inputting registration information from the authorized party local computer system 20.

With respect to the authorized party 120, registration enable the electronic transaction manager 120 to correlate electronic documents 80 selected by the authorized party 120 with that particular authorized party 120 and with all other authorized parties 120 as identified by the authorized party 120, during the registration process. Registration further allows the electronic transaction manager 1200 to associate all electronic document transactions 90 with that particular registration account 31 which is integral to the function of the present invention for the purpose of managing the electronic document transaction cycle. With respect to the notary public 140, registration entails the notary public 140 providing verification information to register with the present invention as a duly licensed notary public 140. The notary public registration account 55 is recorded in the electronic transaction manager database 60, and is subject to verification by the rules-based integrity check 100 prior to the desktop manager 30 executing the notarization processes and methods 55.

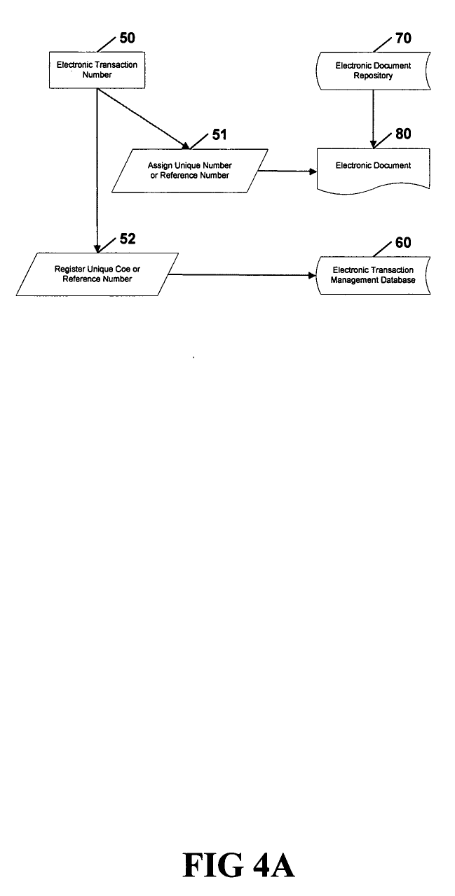

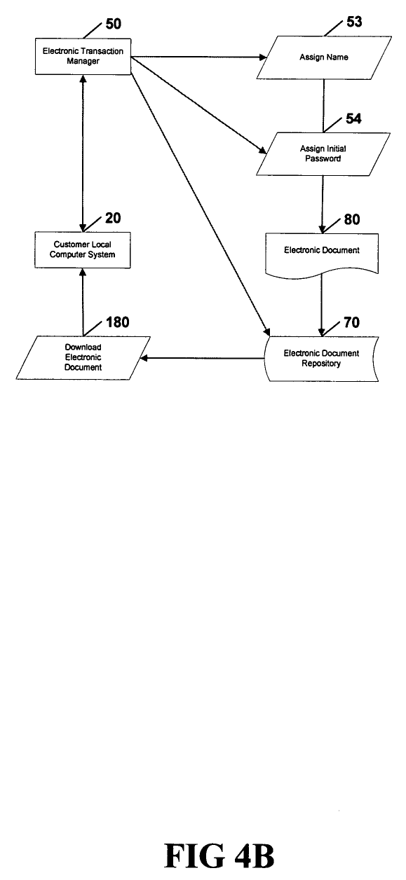

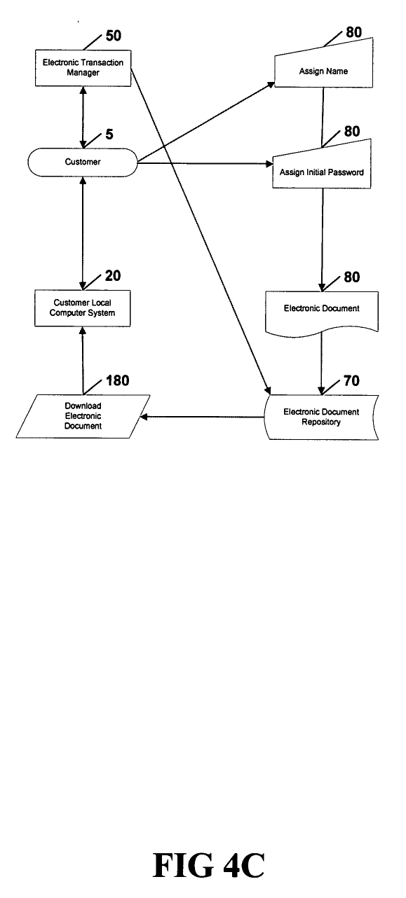

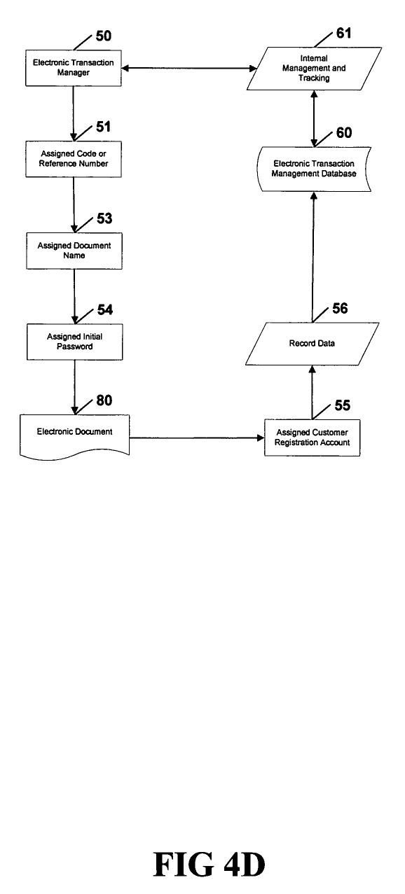

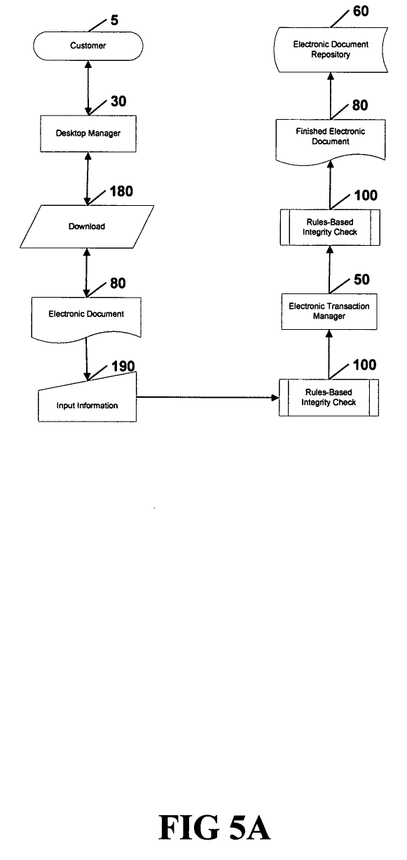

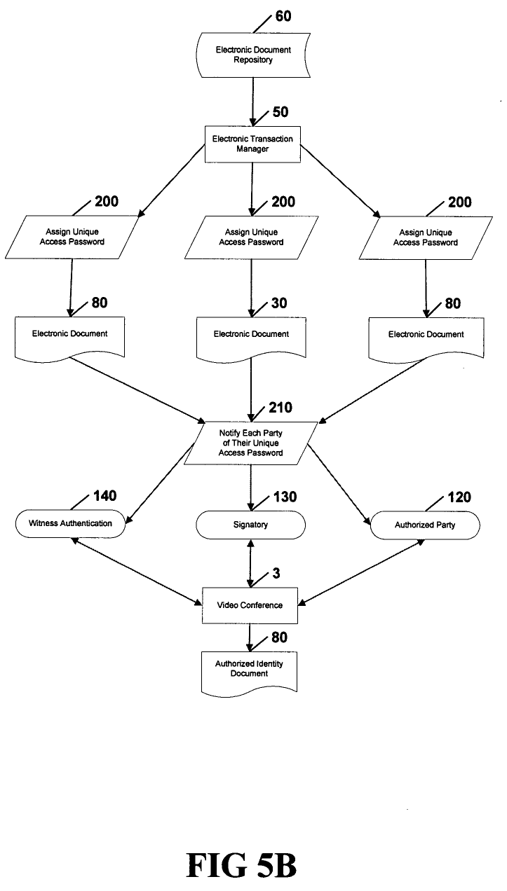

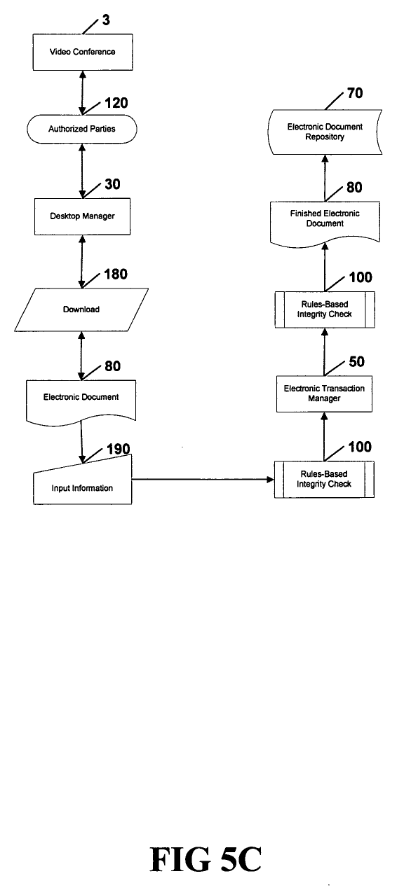

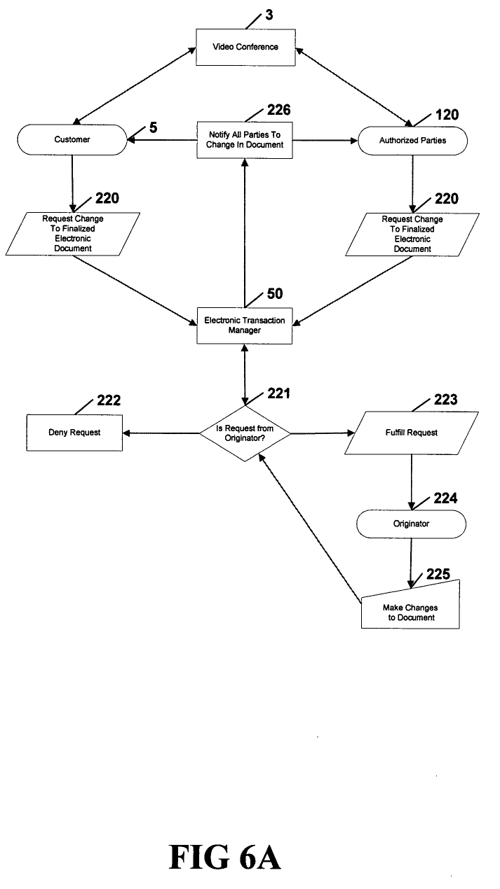

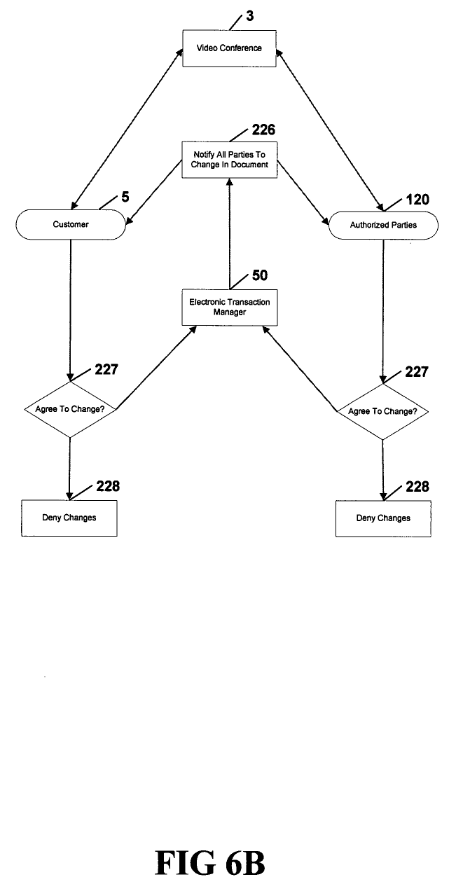

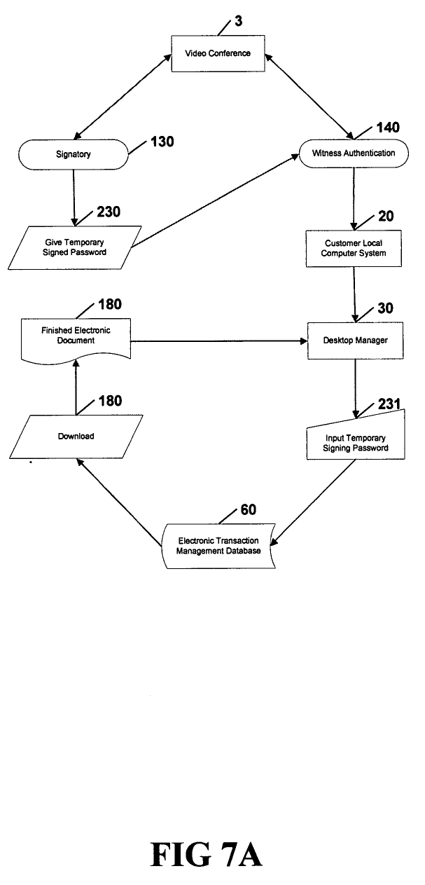

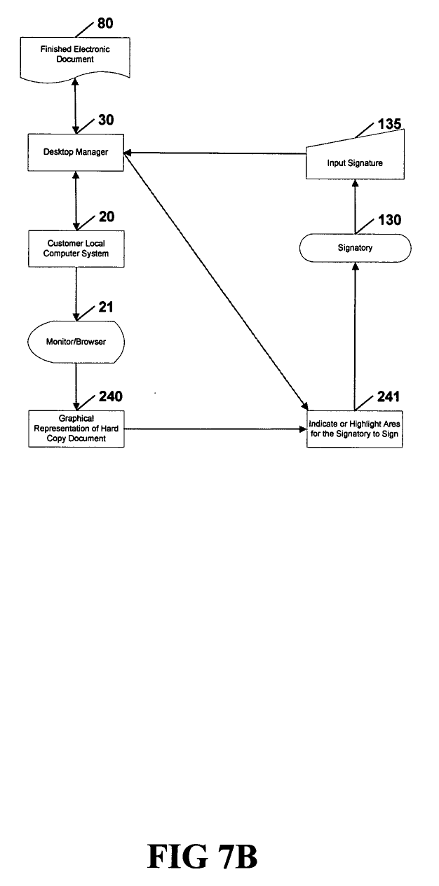

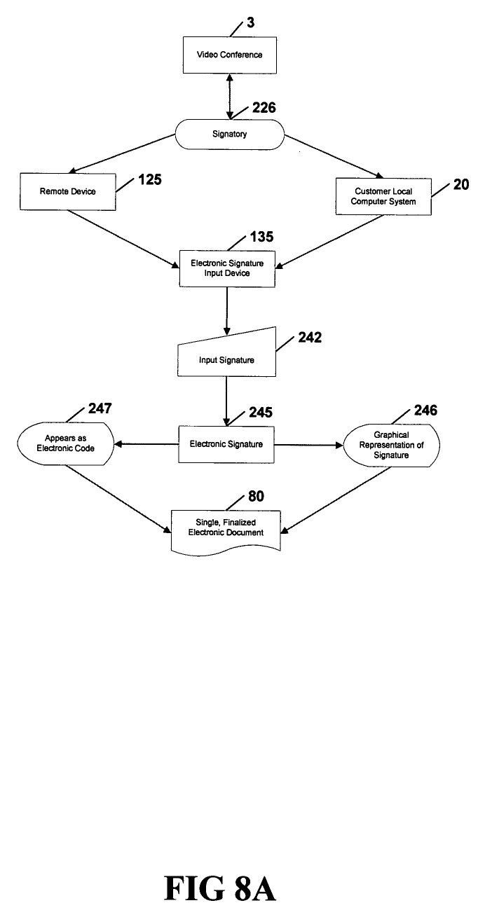

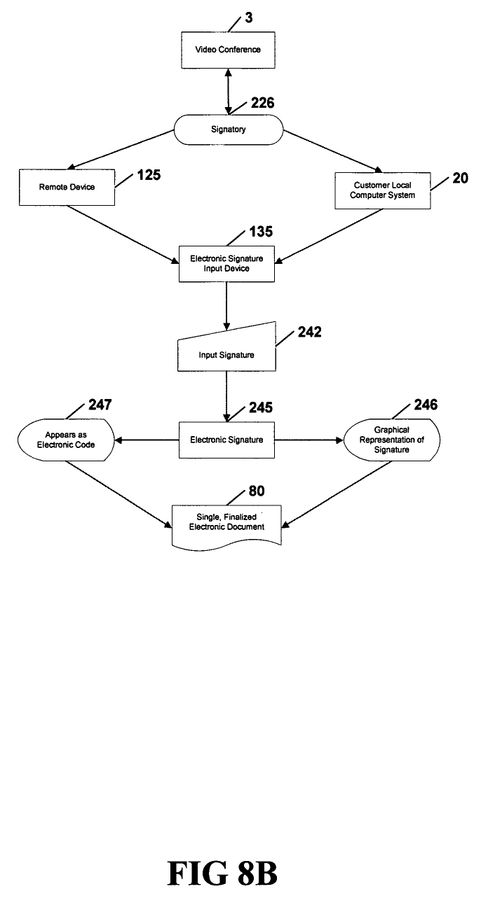

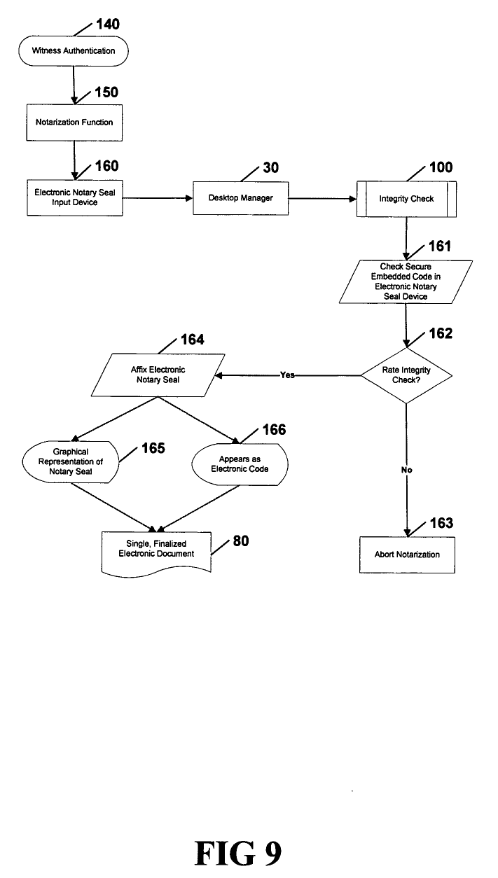

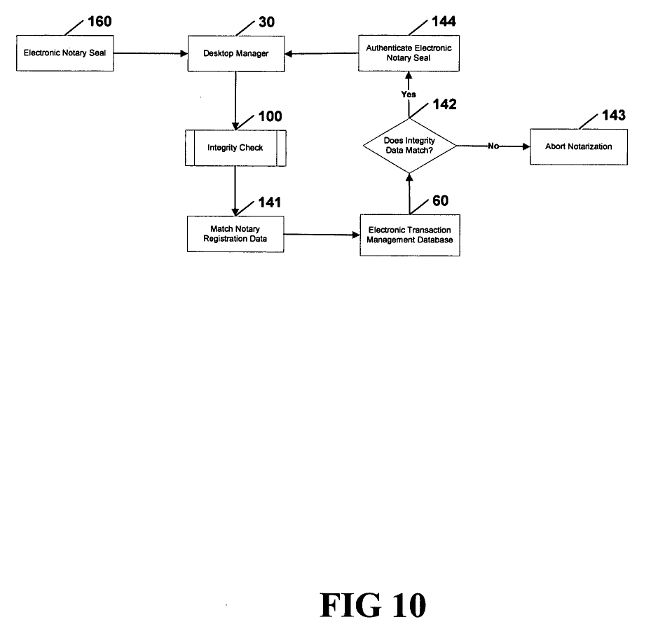

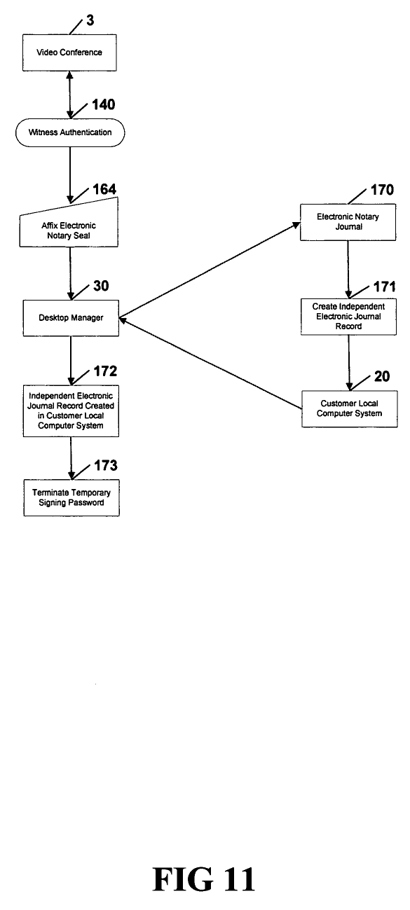

With reference to FIGS. 4A through 4D, after establishing a registration account 55 with the electronic transaction manager database 60, the authorized party 120 selects the electronic document 80 required to be managed by the electronic transaction manager and to be notarized by the notary public 140. With reference to 4A, each electronic document 50 is assigned 51 a code or a form of internal identification 52 by the electronic transaction manager 53 as a priori, this code or reference number 52 is separate and distinct from the registration account 55.

Upon a authorized party 120 selecting an electronic document 80 from the electronic document repository 70, the electronic transaction manager 50 automatically correlates the electronic document 80 to the authorized party registration account 55 by way of the code or reference number 52. With reference to FIG. 4B the electronic transaction manager 55 further assigns a password 54 and a document name 53 to each electronic document 80 selected by the authorized party 120. Alternatively, with reference to FIG. 4C, the authorized party 120 may input a document name 53 and corresponding password 54 to the electronic document 80. Otherwise, the authorized party 120 may opt to use the default document name 53 and corresponding password 54 provided by the electronic transaction manager 55. With reference to FIG. 4D, upon assigning a document name 53 and a corresponding password 54, the electronic transaction manager 55 automatically registers 56 each electronic document 80, its corresponding code 52, document name 53, password 54 and correlating authorized party registration account 55 in the electronic transaction manager database 60.

With reference to FIG. 5A, upon the download of a particular electronic document 80 from the electronic document repository 70, the desktop manager 30 displays the selected electronic document 80 on the browser 21 of the authorized party local computer system 20. The desktop manager 30 directs the authorized party 120 to each place in the electronic document 80 where information 190 is required to be input into the electronic document 80 by the authorized party 120. In the preferred embodiment, the electronic document 80 appears as a graphical representation on the browser 21 of the local computer system 20, and areas in the electronic document 80 requiring information to be input 190 shall be highlighted or otherwise indicated by the desktop manager 30.

Alternatively, the electronic document 80 appears as a graphical representation on the browser 21 of the local computer system 20 alongside fields; information being input into these fields that appear in the graphical representation of the electronic document 80. Information may be comprised of varied sorts, including personal information such as a driver's license, numerical information such as a purchase price, expert opinion, and the like. The desktop manager 30 further determines which fields where information is to be input are restricted and which fields are permissive. That is, certain parties may be prohibited from inputting information 190 into restricted fields in the electronic document 80. The determination of which fields are restrictive is made by the authorized party 120 during the registration process, or in some instances, after downloading the electronic document 80, but always prior to posting the electronic document 80 for retrieval by a subsequent authorized party 120.

With reference to FIG. 5A, upon inputting the required information 190 into the electronic document 80 using the authorized party local computer system 20, the authorized party 120 uploads the electronic document 80 to the electronic document repository 70 for retrieval by a subsequent authorized party 120. Subsequent authorized parties 120 are identified by the authorized party 120 in the authorized party registration account 55.

The desktop manager 30 executes the rules-based integrity check 100 to ensure that all of the required information is present before permitting the electronic document 80 to upload to the electronic document repository 70. The rules-based integrity check 100 entails that the following criteria are met: (i) all of the required information is present; and (ii) the electronic document 80 has not been altered in any way, with the exception of the permissive information input. If the electronic document 80 fails the rules-based integrity check 100, in the first instance (i) the desktop manager 30 alerts the authorized party 120 with instructions to complete the missing information and reload the electronic document 80 to the electronic document repository 70. If the electronic document 80 fails the rules-based integrity check 100 in the second instance (ii), the desktop manager 30 alerts the authorized party 120 that the electronic document 80 may not be uploaded to the electronic document repository 70. Once the electronic document 80 is uploaded to the electronic document repository 70 for retrieval by a subsequent authorized party 120, no subsequent authorized party 120 may alter information entered by a previous authorized party 120 or by the authorized party 120.

Upon a authorized party 120 uploading an electronic document 80 to the electronic document repository 70, the electronic transaction manager 1200 automatically runs a rules-based integrity check 100. The rules-based integrity check 100 entails confirming that the following criteria are met: (i) all of the required information is present in the electronic document 80; (ii) that the electronic document 80 corresponds to a registration account 55; and (iii) that the electronic document 80 has not been altered in any way, with the exception of permissive information being added to the electronic document 80. Should these criteria fail, the electronic transaction manager 55 will not accept the electronic document 80 to be posted in the electronic document repository 70. After passing the rules-based integrity check 100, the electronic transaction manager 55 records the transaction status 90 in the electronic transaction manager database 60 and posts the electronic document 80 for retrieval by a subsequent authorized party 120.

With reference to FIG. 5B, an authorized party 120 is an individual or entity identified by the initial authorized party 120 in the registration account 55 as being allowed to access the electronic document 80. The electronic transaction manager 50 assigns and disseminates 210 an access password 200 to the other authorized party 120 per the instructions of the initial authorized party 120. The access password 200 permits the authorized party 120 to download 180 the electronic document 80 from the electronic document repository 70. In the preferred embodiment of the present invention, a subsequent authorized party 120 downloads 180 the electronic document 80 using an access password 200 supplied by the electronic transaction manager 1200. In another embodiment, an authorized party 120 downloads the electronic document 80 using an access password 200 supplied by the authorized party 120. In either embodiment, the access password 200 is additional and different from the initial password 125 assigned to the electronic document 80. No subsequent authorized party 120 shall have the same access password 200 as another authorized party 120 nor shall they have access to any access password 200 other than their own.

With reference to FIG. 5C, a subsequent authorized party 120 utilizes the present invention per the same method as did the authorized party 120. That is, an authorized party 120 runs the desktop manager 30 on a authorized party local computer system 20 and downloads the electronic document 80 using the document name 1203 and the access password 200. The desktop manager 30 displays the electronic document 80 on the browser 21 of the authorized party local computer system 20, and indicates where information is to be input 190 into the electronic document 80 per the methods described above.

The other authorized party 120 inputs the required information 190 where indicated by the desktop manager 30 and uploads the electronic document 80 to the electronic document repository 70 to be managed by the electronic transaction manager 55. The electronic transaction manager 55 may post several copies of the electronic document 80 so that several other authorized parties 120 may access the electronic document 80 singularly or simultaneously in time, each using their own unique access password 200. Upon a determination by the electronic transaction manager 55 that all of the required information is input 190 into the electronic document 80 by the authorized party 120 and each of the authorized parties 120 identified in the registration account 55, the electronic transaction manager 55 amalgamates the information from every party into a single finalized electronic document 80.

With reference to FIGS. 6A and 6B, only the originator 224 of the information input 190 into the electronic document 80 (whether it be a authorized party 120 or other authorized party 120) may alter or otherwise change such information after the originator 224 has successfully uploaded the electronic document 80 to the electronic document repository 70. Should the originator 224 of the information, wish to add, delete or otherwise modify information after posting the electronic document 80 for retrieval by a subsequent authorized party 120, the electronic transaction manager 55 automatically executes a rules-based integrity check 100 to the changed information. The rules-based integrity check 100 executes upon the originator 224 of information re-posting the electronic document 80 to the electronic document repository 70. The rules-based integrity check 100 compares the modified information in the electronic document 80 with the original information in the electronic document 80. The rules-based integrity check 100 compares the modified information with the original information and extracts the specific modifications that have been made to the electronic document 80. The electronic transaction manager 55 notifies 226 each party to the transaction via the electronic transaction status board 110 that the electronic document 80 has been modified, and the time and date of the modification. The electronic transaction manager 55 further identifies the party 224 that made the modification and specifies what modifications have been made to the electronic document 80. Each party to the transaction must respond to the electronic transaction manager 55 by way of an affirmative action 227, such as activating an “I Accept” icon, or some variation thereof, prior to the electronic transaction manager 1200 accepting the modified electronic document 80 to be posted in the electronic document repository 70.

The electronic transaction manager 55 further consists of an electronic transaction status board 110. The electronic transaction status board 110 functions as an on-line virtual message communication center. The electronic transaction status board 110 automatically receives tracking information from the electronic transaction manager 55 that consists of the electronic document transaction 90. That is, upon a successful upload of the electronic document 80 to the electronic document repository 70, irrespective of the point in the transaction cycle, the electronic transaction manager 55 automatically posts the time, date, and the party that posted the electronic document 80 to the electronic transaction status board 110.

Likewise, the electronic transaction manager 55 posts when a transaction cycle is complete, including the time and date of notarization 164 on the electronic transaction status board 110. The electronic transaction status board 110 further functions as a virtual message center where the various parties to the transaction may inform one another of the respective status of the electronic document 80, i.e. a lender may be waiting on an appraisal, or the signatory 130 may be ill and unable to conclude the transaction at this point in time. Likewise, the parties may post questions or requests for other parties on the electronic transaction status board 110. The electronic transaction status board 110 allows the parties to the transaction to have constant and instant information and communication that is readily accessible. However, access to the electronic transaction status board 110 is password protected and only the authorized party 120 and subsequent authorized parties 120 may access the electronic transaction status board 110. Each party to the transaction is assigned an individual electronic message board that resides in electronic transaction status board 110. Each individual electronic message board is unique to the corresponding party, and access to input information into an individual electronic message board is restricted to the corresponding party to whom it is registered. Nonetheless, each party may view the contents of any one of the individual electronic message boards.

With reference to FIG. 7, the electronic transaction manager 55 determines when the electronic document 80 is ready to be electronically signed by the signatory 130. The electronic document 80 is ready for signature when all of the required electronic documents 80 needed to complete the transaction are uploaded into the electronic document repository 70, and the rules-based integrity check 100 ensures that all of the required information 190 is completed in each of the electronic documents 80. Upon a determination that the electronic document 80 is ready for signature, the electronic transaction manager 55 encrypts the electronic document 80 and applies a time and a date stamp. Too, at this time, the electronic transaction manager 55 assigns a temporary signing password 230 to each signatory 130. Each signatory 130 is given a temporary signing password 230 that is unique to the signatory 130. No two signatories 130 shall have a common temporary signing password 230. The electronic transaction manager 1200 registers each temporary signing password 230 with the correlating electronic document 80 to be signed in the electronic transaction manager database 60. The temporary signing password 230 is a function of the electronic transaction manager 55 and is distinct from the initial password 1203 assigned to the electronic document 80, and from the access password 200 assigned to the subsequent authorized party 120.

The electronic transaction manager 55 alerts the signatory 130 that the electronic document 80 is ready to be electronically signed 135 and electronically notarized 115. Likewise, the electronic transaction manager 1200 disseminates the temporary signing password 230 to the signatory 130 along with a list of locations for a notary public 140 with the means to electronically notarize 112 the electronic document 80 according to the present invention. The signatories 130 may be geographically remote, as in different states or countries, each utilizing a different notary public 140 who shall access the same electronic document 80 from the electronic repository 70 for notarization 115. The signatory 130 discloses the name of the electronic document 80 and the corresponding temporary signing password 230 to the notary public 140. Using the temporary signing password 230, the notary public 140 downloads the electronic document 80 from the electronic document repository 70 using a authorized party local computer system 20 that runs the desktop manager 30.

With reference to FIG. 7B, after reviewing the electronic document 80 in the presence of the notary public 140, the signatory 130 affixes an actual hand-written signature to the electronic document 80 using the electronic signature input device 135. The desktop manager 30 highlights or otherwise indicates 241 each and every place where a signature or initials is required in the electronic document 80 that appears on the browser 21 of the authorized party local computer system 20 as a graphical representation 240. Indication will typically appear as an icon such as an arrow or some other pointing device that physically demonstrates on the browser 21 of the authorized party local computer system 20 which part of the electronic document 80 the signatory 130 is initializing or signing. To ensure the signor's intent, each place indicated by the desktop manager 30 requiring a signature or initials must be physically input using the electronic signature input device 135. That is, the desktop manager 30 will not replicate signatures if multiple signatures are required in the electronic document 80, but mandate that the signatory 130 sign each place in the electronic document 80 where indicated by the desktop manager 30, 241.

With reference to FIG. 8A, the signatory's 130 actual hand-written signature 245 is captured by way of an electronic signature input device 135, and affixed to the electronic document 80 by the desktop manager 30. The electronic signature input device 135 may be a part of the authorized party local computer system 20 or a device external to it 125. The electronic signature input device 13120 utilizes the traditional pen and ink method of physically signing one's own signature. The desktop manager 30 electronically affixes 242 the signature to the electronic document 80 as a graphical representation 246. Alternatively, the electronic signature 245 captured by the electronic signature input device 135 may be encrypted as a code 247 that is unique to the signatory 130 and linked with the corresponding electronic document 80.

With reference to FIG. 8B, upon witnessing the signatory 130 physically sign the electronic document 80, the notary public 140 affixes an actual hand-written signature 245 to the electronic document 80 where indicated by the desktop manager 30, using the electronic signature input device 135. Per the method referenced above, the desktop manager 30 will not replicate the notary public's 140 signature 245 if multiple signatures are required, but mandate that the notary public 140 sign each place where indicated by the desktop manager 30. Per the method above, the electronic signature input device 135 utilizes the traditional pen and ink method whereby the notary public 140 physically signs the electronic document 80 that appears as a graphical representation 240 of the hard copy document it replaces. The electronic signature of the notary public 140 appears on the electronic document 80 as a graphical representation 246. Alternatively, the electronic signature 245 captured by the electronic signature input device 135 may be encrypted as a code 247 that is unique to the notary public 140 and linked with the corresponding electronic document 80.

With reference to FIG. 9, after affixing a signature 245 to the electronic document 80, the notary public 140 affixes an electronic notary seal 115 to the electronic document 80. The notary public 140 electronically affixes the seal to the electronic document 80 using the electronic notary seal input device 160. The electronic notary seal input device 160 is independent of the desktop manager 30 but operates only in conjunction with the desktop manager's 30 notarization function. The desktop manager's 30 notarization function only operates when activated by the electronic notary seal input device 160. The electronic notary seal input device 160 may be a function embedded in the authorized party local computer system 20 or a portable device that attaches to the authorized party local computer system 20. In the preferred embodiment of the present invention, the electronic notary seal input device 160 is a remote device that remains in the sole possession of the notary public 140. The notarization function of the desktop manager 30 will only run when the electronic notary seal input device 160 is attached to the authorized party local computer system 20. The remote electronic notary seal input device 160 is a hardware-based security portable device that attaches to the serial or parallel printer port of the authorized party local computer system 20, including a laptop. The remote electronic notary seal input device 160 utilizes a hardware key that uses codes and passwords embedded inside the key to control access to the desktop manager's 30 notarization function. While activated, the electronic notary seal input device 160 receives encoded data from the desktop manager 30 and decodes it in a way that cannot be imitated. The decoded data that is returned from the remote electronic notary seal input device 160 is deployed in the desktop manager 30 so that it affects the mode in which the manager 30 executes the notarization function. The remote electronic notary seal input device 160 is programmed to execute a notarization 164 upon a verified match 162 with the desktop manager 30. After decoding, a verified match 162 will execute the notarization function of the desktop manager 30 that in turn activates the execution of the electronic notary seal which is embedded in the remote electronic notary seal input device 160. The desktop manager 30 indicates by way of an arrow or an icon that appears on the browser 21 of the authorized party local computer system 20 where the electronic seal shall be input and appear on the electronic document 80. In the preferred embodiment of the present invention, the notary seal appears as a graphical representation 165 of a traditional notary seal on the electronic document 80. The graphical representation 165 may include an encrypted code that is affixed to the electronic document 80 that contains the date and time the notary public's 140 seal was affixed and the verification information of the notary public 140 provided in the notary public's registration account 125. As stated, verification information consists of that information required by law to license and register the notary public.

Alternatively, the remote electronic notary seal input device 160 may input an electronic notary seal in the form of an encrypted barcode 166 that appears on the electronic document 80. The notary barcode seal 166 of the remote electronic notary seal input device 160 is verified by the desktop manager 30 that utilizes a secure server database specifically configured to authenticate the notary barcode seal 166. The notarization function of the desktop manager will only execute upon a verification from the secure server of a positive code match with the notary barcode seal 166 embedded in the remote electronic notary seal device 160. A standard barcode reader uses light to convert the notary barcode into an electrical signal. The barcode reader measures the relative widths of the bars and spaces of the notary barcode, translates the code into regular characters, and transports the translation to the host computer server 40. Each notary barcode seal 166 begins with a special start character and ends with a special stop character. The notary barcode seal 166 may include a checksum character just before the stop character. The checksum is calculated using the characters in the notary barcode seal 166 before the notary barcode seal 166 may be affixed to the electronic document 80. The barcode reader performs the same calculation and compares its answer to the checksum it read at the end of the notary barcode seal. If the two calculations do not match, the barcode reader shall invalidate the notary barcode seal 166. The barcode of the present invention is not a standard bar code scheme that is typically obtained from an independent party, rather the barcode is a proprietary-based, secure software application embedded in the remote electronic notary seal input device 160. The data in a bar code denotes a reference number that the secure server utilizes to look up the associated computer record that contains descriptive verification data of the notary public 140 to whom the corresponding barcode seal is registered to. The barcode may further contain the date and time the notary public's 140 seal was affixed and the verification information for the notary public 140.

With reference to FIG. 10, the remote electronic notary seal input device 160 is pre-configured uniquely for each notary public 140 and is registered to the notary public 140. Each electronic notary seal input device 160 contains a particular serial number assigned and registered to the notary public 140 by the electronic transaction manager 55. The desktop manager 30 verifies that the serial number associated with the remote electronic notary seal input device 160 is an authorized, registered device. The notarization function of the desktop manager 30 will run with only upon verification of registration. The notary public 140 may choose to add extra coding to the remote electronic notary seal input device 160 in the form of a password or code for additional security. The portable hardware device allows the notary public 140 to have sole control and possession of the electronic notary seal input device 160, thereby securing compliance with prevailing governmental regulations. The portable hardware device further allows the notary public 140 to electronically notarize electronic documents 80 wherever the authorized party local computer system 20 has access to the internet or TCP/IP connectivity 10, including a laptop. The portable hardware device is easily transportable and can be used at diverse locations to another without a cumbersome uninstall/install process.

With reference to FIG. 11, upon affixing the notary signature and seal, the desktop manager 30 automatically executes the electronic notary journal 170. The electronic notary journal 170 creates an independent electronic record 171 of the notarization transaction. The electronic notary journal 170 contains all of the information required by law to legally enforce the notarization of the electronic document 80. Upon recording the notarization transaction in the electronic notary journal 170, the desktop manager 30 encrypts the signed, notarized, electronic document 80 and applies a time and date stamp. Any changes made to the electronic document 80 after this point in time invalidate the notary public's seal. The signed, notarized, electronic document 80 is uploaded by the notary public 140 onto the host computer server 40. Upon uploading the electronic document 80 to the host computer server 40, the temporary signing password 230 terminates. A signatory 130 to the electronic document 80 may have the notary public 140 print a hard copy of the electronic document 80 out, if so desired. The host computer server 40 archives the electronic document 80 for future use and retrieval by approved parties. Upon archival of the electronic document 80, the video conference 3, between the witnessed authentication 140, the authorized party 29, and the signatory 130, is terminated.

### DEFINITIONS

### Notary Public or Witnessed Authentication

Notary Public or Witnessed Authentication includes, but is not limited to:

A notary public is an officer who can administer oaths and statutory declarations, witness and authenticate documents and perform certain other acts varying from jurisdiction to jurisdiction, including commercial or personal documents which originate from or are signed in another country to be notarized before they can be used or officially recorded or before they can have any legal effect.

Witnessed authentication is an authorized agent who can administer oaths and statutory declarations, witness and authenticate documents and perform certain other acts varying from jurisdiction to jurisdiction, including commercial or personal documents which originate from or are signed in another country to be notarized before they can be used or officially recorded or before they can have any legal effect.

### Video Conference

Video Conference includes, but is not limited to:

A videoconference, also known as a videoteleconference, is a set of interactive tellecommunication technologies which allow two or more locations to interact via two-way video and audio transmissions simultaneously. The core technology used in a videoteleconference (VTC) system is digital compression of audio and video streams in real time.

A web conference to hold group interactions or real time transactions. The term refers specifically to live or synchronous transactions. The most basic feature of a web conference is screen sharing, whereby conference participants see whatever is on the presenter's screen. Usually this is accompanied by voice communication, either through a traditional telephonic connection or through VOIP or IM or text chat.

### Authenticated Identity Document

Authenticated Identity Document includes, but is not limited to:

A hard copy drivers license, or a professional license, or a passport, or a government issued identity card, or a contract.

An electronic drivers license, or a professional license, or a passport, or a government issued identity card, or a contract.

A biometric hard copy drivers license, or a professional license, or a passport, or a government issued identity card, or a contract.

A biometric electronic hard copy drivers license, or a professional license, or a passport, or a government issued identity card, or a contract.

What is claimed:

1. A method for providing and performing identity and signature authentication services using a paperless electronic document platform, the internet or other TCP/IP (Transmission Control Protocol/Internet Protocol) based network, a video conference network, a customer local computer system, a desktop manager, a host computer server, an electronic transaction manager, an electronic transaction manager database, an electronic document repository, an electronic document, an electronic transaction, a rules-based integrity check, an electronic transaction status board, notarization processes, an electronic signature input device, an electronic notary seal input device, and an electronic notary journal, said method comprising the steps of: a. a customer using said customer local computer system to access said host computer server; b. said customer using said customer local computer system to register with said electronic transaction manager; c. said customer using said local computer system to access said electronic document repository; d. said customer using said local computer system to download said electronic document from said electronic document repository to said customer local computer system; e. said electronic transaction manager initiating said video conference between at least one of a witnessed authenticator, an authorized part and a signatory on behalf of said customer; f. said electronic transaction manager assigning an initial password to said electronic document; g. said customer using said customer local computer system to input information into said electronic document; h. said desktop manager executing said rules-based integrity check; i. said customer using said customer local computer system to upload said electronic document to said electronic document repository from said customer local computer system; j. said electronic transaction manager executing said rules-based integrity check; k. said electronic transaction manager recording said electronic document transaction in said electronic transaction manager database; l. said customer using said customer local computer system to input information into said electronic transaction status board; m. said electronic transaction manager notifying other authorized parties that said electronic document is ready for retrieval by said other authorized parties; n. said electronic transaction manager assigning an access password to said other authorized parties; o. said other authorized parties using said customer local computer system to download said electronic document from said electronic document repository to said customer local computer system of said other authorized parties, using said access password; p. said other authorized parties using said customer local computer system to input information into said electronic document; q. said desktop manager executing said rules-based integrity check; r. said other authorized parties using said customer local computer system to upload said electronic document to said electronic document repository; s. said electronic transaction manager executing said rules-based integrity check; t. said electronic transaction manager recording said electronic document transaction in said electronic transaction manager database; u. said other authorized parties using said customer local computer system to input information into said transaction status board; v. said electronic transaction manager determining when said electronic document is ready for signature and notarization; w. said electronic document transaction manager notifying a signatory required to sign said electronic document when said electronic document is ready for signature; x. said signatory accessing a notary public, whereby said notary public downloads said electronic document from said electronic document repository; y. said electronic signature input device obtaining the electronic, manual, handwritten signature of said signatory; z. said signatory inputting biometric information, aa. said desktop manager simultaneously affixing said electronic, manual, handwritten signature of said signatory and the biometric information of said signatory to said electronic document; bb. said electronic signature input device obtaining the electronic, manual, handwritten signature of said notary public; cc. said desktop manager simultaneously affixing said electronic, manual, handwritten signature of said notary public to said electronic document; dd. said electronic notary seal input device affixing an electronic notary seal to said electronic document; ee. said desktop manager executing said rules-based integrity check to verify said electronic notary seal is authentic; ff. said desktop manager recording said notarization processes in said electronic notary journal; gg. said desktop manager terminating said video conference and encrypting said electronic document; hh. said notary public uploading said electronic document to said electronic document repository; ii. said electronic transaction manager executing said rules-based integrity check; and jj. said electronic transaction manager archiving said electronic document for future use, reference or retrieval.

2. The method of claim 1 whereby the method of distributing video content in a multi-participant video conference, said conference having one central distributor of video content, the method comprising: a) at the central distributor, receiving participant video images from each participant, b) generating composite images from the received participant images, and c) transmitting said composite images to said participants.

3. The method of claim 1 whereby the method of distributing video content in a multi-participant video conference, said conference having one central distributor of video content, the method comprising: a) at the central distributor, receiving participant audio images from each participant, b) generating audio content from the received participant images, and c) transmitting said composite audio to said participants.

4. The method of claim 1 whereby the method of distributing video content in a multi-participant video conference, said conference having one central distributor of video content, the method comprising: a) at the central distributor, receiving participant electronic data images from each participant, b) generating electronic data images from the received participant images, and c) transmitting said electronic data images to said participants.

5. The method of claim 1 further comprising: at each particular participant's location, a) receiving the composite image transmitted to the particular participant, b) capturing an image of the particular participant; c) rendering said participant images contained within the transmitted composite image with said captured images of the particular participant for display.

6. The method of claim 1, wherein the composite image comprises a plurality of sets of pixels, each pixel set has an identifier that identifies the participant image associated with the pixel set, the method further comprising at each participant's location, utilizing the identifiers of the pixel sets to identify the participant images contained within the transmitted composite image.

7. The method of claim 1, the method further comprising: a) at the central distributor, saving said received video images before generating said composite images, b) comparing the received video image of each participant with the saved preceding video image of the particular participant, and c) utilizing the received video image in generating the composite image if the received video image and the preceding received video image are not identical.

8. The method of claim 1, the method further comprising a computer readable medium storing a compute program for distributing video content in a multi-participant video conference, said conference having one central distributor of video content, the computer program comprising sets of instructions for: a) at the central distributor, receiving participant video images from each participant, b) generating composite images from the received participant images, and c) transmitting said composite images to said participants.

9. The method of claim 1, wherein the central distributor includes a data storage, the computer program further comprising a set of instructions for placing each said received participant image in the said data storage in a non-interleaved manner such that each said received participant image is not interleaved with any of the other received participant images.

10. The method of claim 1, wherein the computer program further comprises sets of instructions for: a) creating a separate composite image for each particular participant, and b) removing each particular participant's received participant image from the particular participant's separate composite image before transmitting the separate composite image to the particular participant.

11. The method of claim 1 whereby said desktop manager further comprises the step of said desktop manager highlights or otherwise indicates each place in said electronic document where the electronic signature of said signatory is to be input into said single, finalized electronic document.

12. The method of claim 11 whereby said signatory inputs said electronic signature into said single, finalized electronic document using said electronic signature input device; and whereby said desktop manager affixes said electronic signature in the designated places of said single, finalized document.

13. The method of claim 12 whereby said electronic signature input device may be a remote device or a function of said customer local computer system, and whereby said electronic signature appears as a graphical representation of said signatory's manual, hand-written signature.

14. The method of claim 12 whereby said electronic signature input device may be a remote device or a function of said customer local computer system; and whereby said electronic signature of said signatory appears in the form of an electronic code.

15. The method of claim 1 whereby said customer establishes a registration account with said electronic transaction manager, whereby said customer inputs verification information to establish said registration account.

16. The method of claim 1 whereby said notary public establishes a registration account with said electronic transaction manager, whereby said notary public inputs verification information to establish said registration account.

17. The method of claim 1 whereby said electronic document repository further comprises a variety of said electronic documents and a plurality of said electronic documents; said electronic documents being represented by category or by type of said electronic document.

18. The method of claim 1 whereby said electronic transaction manager further comprises the step of assigning a unique code or reference number to each said electronic document stored in said electronic document repository; said code or said reference number in said electronic transaction manager database for internal management and tracking of said electronic document.

19. The method of claim 1 whereby said desktop manager further comprises the step of accessing said electronic document repository and selecting said electronic document or a plurality of said electronic document for download to said customer local computer system.

20. The method of claim 1 whereby said electronic transaction manager further comprises the step of assigning a document name and an initial password to said electronic document that is downloaded to said customer local computer system from said electronic document repository.

21. The method of claim 1 whereby said electronic transaction manager further comprises the step of said customer assigning said document name and said initial password to said electronic document that is downloaded to said customer local computer system from said electronic document repository.

22. The method of claim 1 whereby said electronic transaction manager further comprises the step of recording the code or the reference number assigned to said electronic document, said document name assigned to said electronic document, and said initial password assigned to said electronic document in said registration account of said customer for internal management and tracking of said electronic document by said electronic transaction manager.

23. The method of claim 1 whereby said desktop manager further comprises the step of displaying an image of said electronic document on the browser of said customer local computer system, wherein said image being a representation of the hard copy paper document said electronic document replaces.

24. The method of claim 1 whereby said desktop manager further comprises the step of said desktop manager highlighting or otherwise indicates where said information is to be input into said electronic document by said customer, and whereby said customer inputs said information into said electronic document from said customer local computer system.

25. The method of claim 1 whereby said desktop manager further comprises the steps of downloading and uploading said electronic document from said customer local computer system to said electronic document repository.

26. The method of claim 1 whereby said document desktop manager further comprises said rules-based integrity check; said rules-based integrity check comprising a logic process that is executed prior to uploading said electronic document to said electronic document repository from said customer local computer system.

27. The method of claim 1 whereby said electronic transaction manager further comprises said rules-based integrity check; said rules-based integrity check further comprising a logic process that is executed after downloading and uploading said electronic document to said electronic document repository from said customer local computer system.

28. The method of claim 1 whereby said electronic transaction manager further comprises said electronic transaction status board; said electronic transaction status board further comprising the step of said electronic transaction manager automatically inputs said information regarding said electronic document into said electronic transaction status board.

29. The method of claim 1 whereby said electronic transaction manager further comprises an electronic transaction manager database; said transaction manager database further comprising the step or recording said functions of said electronic transaction manager.

30. The method of claim 1 whereby said electronic transaction manager further comprises the step of assigning an access password to said electronic document for retrieval from said electronic document repository by said other authorized parties; wherein each said access password of said other authorized parties is unique.

31. The method of claim 1 whereby said electronic transaction manager further comprises the step of notifying said other authorized parties are notified when said electronic document is ready for retrieval from said electronic document repository.

32. The method of claim 1 whereby said electronic transaction manager further comprises the step of said access password assigned to said electronic document is disseminated to said other authorized parties.

33. The method of claim 1 whereby said desktop manager further comprises the step of said other authorized parties download said electronic document from said electronic document repository to said customer local computer system using said access password assigned to said electronic document.

34. The method of claim 1 whereby said other authorized parties utilize said desktop manager in the same manner and function as did said customer to download said electronic document, input said information into said electronic document, and upload said electronic document to said electronic document repository; said electronic document being subject to said rules-based integrity check by said desktop manager prior to said upload and to said rules-based integrity check by said electronic transaction manager after said upload.

35. The method of claim 1 whereby said electronic transaction manager further comprises the step of said other authorized parties may access multiples copies of said electronic document singularly, or simultaneously, from said electronic document repository, wherein said multiple copies of said electronic document are identical in form and substance.

36. The method of claim 35 whereby said electronic transaction manager further comprises the step of compiling said information input singularly and simultaneously into said copies of said electronic document by said other authorized parties into a single, finalized electronic document.

37. The method of claim 36 whereby said electronic transaction manager further comprises the step of determining when said single, finalized electronic document is ready for signature and notarization.

38. The method of claim 37 whereby said electronic transaction manager further comprises the step of: notifying the signatory that said single, finalized electronic document is ready for signature and; and disseminating said temporary signing password to said signatory.

39. The method of claim 37 whereby said electronic transaction manager further comprising the step of to allow said customer or said other authorized parties to change said information in said single, finalized electronic document, and whereby only the originator who input said information into said electronic document may alter said information.

40. The method of claim 34 further comprising the step of said electronic transaction manager notifies said customer and said other authorized parties when said originator of said information alters said information; and whereby said electronic transaction manager requires said customer and said other authorized parties to expressly agree to said alter of said information.

41. The method of claim 34 whereby said electronic transaction manager further comprises the step of assigning a temporary signing password to said single, finalized electronic document.

42. The method of claim 34 whereby said desktop manager further comprises the step of said notary public downloads said single, finalized electronic document from said electronic document repository using said customer local computer system and said temporary signing password supplied by said signatory.

43. The method of claim 34 whereby said desktop manager further comprises the step of displaying a graphical image of said single, finalized electronic document on the browser of said customer local computer system, wherein said graphical image is a representation of the hard copy paper document said single, finalized electronic document replaces.

44. The method of claim 34 whereby said desktop manager further comprises the step of said desktop manager highlights or otherwise indicates each place in said single, finalized electronic document where the electronic signature of said notary public is to be input into said single, finalized electronic document.

45. The method of claim 42 whereby said notary public inputs said electronic signature into said single, finalized electronic document using said electronic signature input device; and whereby said desktop manager affixes said electronic signature in the designated places of said single, finalized document.

46. The method of claim 43 whereby said electronic signature input device may be a remote device or a function of said customer local computer system; and whereby said electronic signature appears as a graphical representation of said notary public's manual, hand-written signature.

47. The method of claim 43 whereby said electronic signature input device may be a remote device or a function of said customer local computer system; and said electronic signature of said notary public appears in the form of an electronic code.

48. The method of claim 45 whereby said desktop manager further comprises the step of requiring a separate electronic signature for each place said electronic signature is required in said single, finalized electronic document; and whereby said desktop manager will not replicate said electronic signature should multiple electronic signatures be required.

49. The method of claim 43 whereby said desktop manager further comprises the step of said desktop manager highlights or otherwise indicates each place where an electronic notary seal is to be input into said single, finalized electronic document.

50. The method of claim 34 whereby said electronic notary seal input device further comprises the step of said notary public affixes said electronic notary seal to said single, finalized electronic document where indicated by said desktop manager.

51. The system of claim 48 whereby said desktop manager further comprises said rules-based integrity check, whereby said electronic notary seal input device must match a secure code embedded in said desktop manager in order to affix said electronic notary seal to said single, finalized electronic document.

52. The method of claim 48 further comprises said electronic notary seal may appear as a graphical representation on said single, finalized electronic document or may appear in the form of an electronic barcode on said single, finalized electronic document.

53. The method of claim 34 whereby said desktop manager further comprises the step of encrypting said single, finalized electronic document in order to prohibit any changes being made to said single, finalized electronic document.

54. The method of claim 34 whereby said desktop manager further comprises the step of said notary public uploads said single, finalized electronic document to said electronic repository.

55. The method of claim 34 whereby said electronic transaction manager further comprises the step of archiving said single, finalized electronic document for future use or retrieval.

56. The method of claim 1 whereby said desktop manager further comprises the step of said desktop manager highlights or otherwise indicates each place in said electronic document where the electronic signature of said signatory is to be input into said single, finalized electronic document.

57. The method of claim 54 whereby said signatory inputs said electronic signature into said single, finalized electronic document using said electronic signature input device; and whereby said desktop manager affixes said electronic signature in the designated places of said single, finalized document.

58. The method of claim 1 whereby said customer local computer system of said customer further comprises said desktop manager; said desktop manager further comprising the step of using means for said computer local computer system to interface with said host computer server, said electronic transaction manager, said electronic transaction manager database, said electronic document repository, said electronic document, said rules-based integrity check, said electronic transaction status board, said notarization processes, said electronic signature input device, said electronic notary seal input device, and said electronic notary journal.

59. The method of claim 1 whereby said customer local computer system of said notary public further comprises said desktop manager; said document manager further comprising the step of using means for said customer local computer system of said notary public to interface with said host computer server, said electronic transaction manager, said electronic transaction manager database, said electronic document repository, said electronic document, said rules-based integrity check, said electronic transaction status board, said notarization processes, said electronic signature input device, said electronic notary seal input device, and said electronic notary journal.

60. The method of claim 1 whereby said rules-based integrity check of said desktop manager further comprises the step of authenticating said electronic notary seal by matching the verification information associated with said notary seal to said registration account of said notary public.

61. The method of claim 1 whereby said desktop manager further comprises said electronic notary journal; said electronic notary journal further comprising the information required by the governing law of the state or country of said notary public to legally enforce said notarization processes.

62. The method of claim 59 further comprises the step of upon said notary public affixing said electronic notary seal to said single, finalized electronic document, said desktop manager executes said notary journal whereby an independent electronic notary journal record of said notary public is created on said customer local computer system.

63. The method of claim 1 whereby said desktop manager further comprises the step of terminating said temporary signing password upon said desktop manager creating said independent electronic notary journal record.

64. The method of claim 62 whereby said electronic transaction manager terminates said video conference between said witnessed authenticator, said authorized party, and said signatory.

65. The method of claim 1 whereby said electronic document may be a physical hard copy document.

66. The system of claim 65 wherein said hard copy document may contain biometric information, including at least one of the group of a signature, a fingerprint, a handprint, a voice print, a retinal print, or a digital certificate.

67. The system of claim 65 wherein said hard copy document may contain personal identity information, including at least one of a group of date of birth, gender, citizenship, height, weight, eye color, hair color, occupation, residence, or personal history as required by governing agencies.
